(19) United States
(12) Patent Application Publication
(10) Pub. No.: US 2017/0198927 A1
(43) Pub. Date: Jul. 13, 2017

(54) LAMINATE HAVING A CORRUGATED SURFACE AND AN AIR-CONDITIONER COMPRISING THE SAME

(71) Applicant: 2ndAir B.V., Voorburg (NL)

(72) Inventors: Robertus Wilhelmus Jacobus HOLLERING, Voorburg (NL); Henricus Johannes Thijs Marie VAES, Eindhoven (NL); Jan Paul Annie ROOSEN, Eindhoven (NL)

(21) Appl. No.: 15/322,963

(22) PCT Filed: Sep. 30, 2015
(86) PCT No.: PCT/NL2015/050681

§ 371 Date: Dec. 29, 2016

(30) Foreign Application Priority Data
Oct. 2, 2014 (NL) 2013566

(51) Int. Cl. F24F 3/14; B32B 27/32; B32B 5/02; B32B 7/12; B32B 27/12; B32B 3/28

(52) U.S. Cl. CPC F24F 3/1417; B32B 27/12; B32B 3/28; B32B 5/022; B32B 7/12; B32B 27/32; B32B 2260/021; B32B 2262/0276; B32B 2262/04; B32B 2262/062; B32B 2307/72; B32B 2509/00; F24F 2003/1435

(57) ABSTRACT

The laminate comprising a first film of a polymer, a second film of a non-woven textile material, and a third film of a non-woven textile material, wherein the first film is arranged between the second and the third film, and wherein the second film and the third film of the laminate are provided with a corrugated surface provided with a plurality of ribs and valleys in a first direction, and a protrusion arranged in a direction at least substantially perpendicular to the said ribs and valleys. This may be created by thermoforming and for instance comprises a pattern of waves. The laminate is intended for use in an air-conditioner.

### FIELD OF THE INVENTION

The invention relates to the use of a laminate in desiccant-based air conditioning.

The invention also relates to the laminate as such and to an air-conditioning apparatus therewith.

### BACKGROUND OF THE INVENTION

Liquid desiccant-based air conditioners are considered a promising energy-efficient alternative for existing air-conditioning systems. The liquid desiccant allows the absorption of humidity. Moreover, the liquid desiccant may be easily transported, so that the cooling or drying of air may be carried out at different locations. The air-conditioner suitably comprises a heat and mass exchange (hereinafter also HMX) module for dehumidification and for regeneration. These HMX modules are typically used in combination with evaporators for cooling of air.

For sake of clarity, the term ‘HMX-module’ is used within the context of the present invention to refer to any module for use in a conditioning system for air and/or another gas. Where reference is made to an air-conditioner module, this is to be understood as synonym. The conditioning system may be arranged to condition humidity and/or temperature of the air. The conditioning system is typically used for air, such as available in offices, stables, houses, theatres, museums, sport halls, swimming pools and other buildings. The conditioning system may alternatively be used for conditioning an industrial gas flow.

A typical example of liquid desiccant is a concentrated salt solution of LiCl. Such a salt solution however has as disadvantages that LiCl may be hazardous for human health and that the concentrated LiCl solution is highly corrosive. It is therefore to be avoided that the LiCl is carried over into the air during the air-conditioning. The liquid desiccant is therefore often used in combination with a membrane, such as for instance known from WO2009/094032A1. That prior document discloses a module design wherein flow of cooling fluid, desiccant flow and air flow are integrated into a single multilevel module. As shown in FIG. 1 of WO2009/094032A1, the air flow (inlet airstream) runs in parallel to the liquid desiccant flow. This reduces the overall both heat and mass transfer efficiency relative to a counter-current flow design.

Another option is the use of a porous material. One such module is known from WO00/55546 (Drykor). The said patent application describes several options for the flow of a thermally conditioned desiccant composition over surfaces of a plate. According to one of the options (FIG. 2), use is made of a plate with a cellulose sponge. In another option, use is made of spraying nozzles so as to distribute the desiccant composition over the surface of the plate. The feasibility of this solution is not demonstrated, but WO2013/094206 states in paragraph [0005] that the design of precooling requires a high flow rate of the desiccant flow. This has the disadvantage of desiccant droplet creation and consequent carryover in the air stream. Such carryover is highly undesired and a major hurdle for the adoption of this type of air-conditioners. According to WO2013/094206, it may only be prevented by substantial filtration of the air stream resulting in high pressure losses.

Another module is known from WO2013/094206 (Sharp). This module mentions the use of a surface of porous textile (page 6-7, par [0023]). It is observed that a flocked surface of 0.5 mm Nylon fibres, when saturated with liquid desiccant, provides adequate surface wetting at desiccant flow rates of 0.5-1.0 liters/m2/hour. However, such a low flow rate is only feasible in combination with plates comprising internal cooling means, such as enclosed channels for refrigerant. Such a plate design is very expensive, and therewith limits the commercial feasibility of this type of liquid desiccant air conditioners.

It is observed that this module may be either used to cool process air, or alternatively in an indirect method, wherein the refrigerant is cooled by means of evaporation of liquid into outside air, such as known from US2010/0212346A1. Herein, no desiccant is used but merely water, which is distributed vertically and horizontally. Particularly, a vertical plate of wicking material is herein combined with a further evaporative media having a corrugated structure and hence a large surface area, and locally in contact with the wicking material. The wicking material will take the water up in vertical direction and the evaporative media will spread the water into the lateral direction. Therewith, the evaporation is further enhanced. However, the combination of wicking material and evaporative media leads to a relative bulky structure, requiring a large area for evaporation.

Therefore, it is desired to improve existing modules to be more efficient.

More particularly, it is an object of the invention to improve the basis structure of the invention, for use in either indirect evaporation systems or desiccant type systems, with or without additional cooling with a refrigerant.

### SUMMARY OF THE INVENTION

According to a first aspect of the invention, a laminate is provided comprising a first film of a polymer, a second film of a non-woven textile material and a third film of a non-woven textile material, wherein the first film is arranged between the second and the third film, and wherein the second film and the third film of the laminate are provided with a corrugated surface provided with a plurality of ribs and valleys in a first direction, and a protrusion arranged in a direction at least substantially perpendicular to the said ribs and valleys.

According to a second aspect of the invention, an air-conditioner is provided comprising a plurality of plates each comprising a laminate comprising a first film of a polymer and a second and a third film of a non-woven textile material, which second and third film of the laminate is provided with a corrugated surface, said second and third films being present on opposite sides of the first film, wherein the corrugated surface is provided with a plurality of ribs and valleys in a first direction, and further with a protrusion arranged in a direction at least substantially perpendicular to the said ribs and valleys.

According to a third aspect, the invention relates to the use of such a laminate and/or such an air-conditioner for air-conditioning process air, wherein more particularly liquid desiccant is used and is designed to flow in and/or at the surface of the second film.

Surprisingly, the present laminate fulfils the functions of both the wicking material and the evaporative media as disclosed in US2010/0212346, and has a sufficient mechanical strength for use as a plate. Therewith, it is feasible for use in an air-conditioning module with a large number of plates at mutually a small distance, enabling modules with sufficient density to become efficient. Such modules may even be efficient without the additional use of a refrigerant for cooling or in an indirect manner. The first direction is herein particularly the direction of the liquid flow. The ribs and valleys are suitably curved, so as to obtain a continuous surface rather than a plurality of side faces with edges between said faces. The plurality of ribs is more particularly wave-shaped or shaped in the form of a sinusoidal function.

The protrusion is also suitably curved. It serves as a strengthening protrusion. It was found that one or a couple of such protrusions result in a laminate having sufficient rigidity for use as a plate, even when the thickness of the laminate is limited to thicknesses of less than 1 cm with a surface area (one surface) of more than 100 cm². Preferably, the surface area of the plate is at least 0.1 m², more preferably at least 0.5 m², or even over 1 m². The thickness may be reduced to less than 0.5 cm.

The thickness is herein defined as the thickness in a planar portion outside a protrusion and outside the wave-shaped portion. It is deemed beneficial that the plate has such planar portion, for instance in the form of an annular ring at the edge of the plate, so as to facilitate assembly.

The use of a non-woven material is deemed advantageous in the process of shaping the surface of said second film with the textile material. This surface shaping process more particularly leads to a larger surface area. This is more compatible with a non-woven material than with a woven material. Moreover, it is deemed that the non-woven material is beneficial for the bonding with the first film, and particularly in the embodiment wherein the textile material forms an interlayer with the semi-crystalline polymer without the presence of an adhesive. Suitably, the textile material is fully non-woven, but a mixture of a woven material and a non-woven material is also feasible.

The polymer film is typically chosen from an engineering plastic. Preferably, the polymer film has a glass transition temperature above 40° C., more preferably above 60° C. or even above 80° C., and/or is semi-crystalline at room temperature, or even at use temperature up to 40° C., up to 60° C. or even up to 80° C. This state or microstructure has the advantage that the polymer film inherently has stiffness, which is suitable to stabilize the laminate in use. In view of the intended application in air-conditioning systems such as dehumidifiers, in which an air flow runs in an air-channel between adjacent laminate, the laminate should not deform under the mere force of an air flow in the air channel. More particularly, it is deemed suitable that the laminate is substantially freestanding when in use.

In one embodiment, the laminate of the first film and the second film comprises an adhesive for bonding the first and the second film. Suitable adhesives are for instance acrylates and copolymers of an olefin and a vinyl ester or vinyl acid, such as the ethylene-vinylacetate (EVA) copolymer. The latter vinylic polymer has the advantage that it is less susceptible for hydrolysis (depolymerisation) by water or desiccant during use.

In a preferred embodiment, the polymer and the textile material are thermally bonded to each other. Thereto, the polymer suitably has a melting temperature of at least 100° C., preferably at least 120° C. and more preferably at least 140° C. Preferably, the melting temperature of the semi-crystalline polymer is at most 240° C., preferably at most 220° C. or even at most 200° C. With lower melting temperatures, the crystallinity is typically insufficient to ensure stability of the laminate during use with hot aqueous solutions. With higher melting temperatures, it becomes impossible to achieve the thermal bonding. The thermal bonding more particularly results in anchoring of the textile material in the semi-crystalline polymer. The melting temperature may even be as high as 160° C.

Suitable engineering plastics are known per se and comprise the classes of polyolefins, polyethyleneterephtalates (PET), polycarbonate (PC). The engineering plastics may be reinforced, for instance by means of glass-fiber.

Suitable semi-crystalline polymers are for instance propylene homopolymers (PP), a semi-crystalline copolymer of ethylene with polypropylene and/or other α-olefins (for instance as known as high-density polyethylene), terpolymers of polypropylene, polyethylene and polybutylene, fluorinated polyolefines, such as polyvinylidenefluoride (PVDF), and copolymers thereof, for instance with polypropylene or hexafluoropropylene, polyetherketone (PEK) poly(ether-ketone-ketone) polymers (PEKK), poly-hydroxybutyrates (PHB), polyetheretherketones (PEEK), polyphenylenesulfides (PPS). Fiber-enforced composites hereof, typically enforced with glass fiber, for instance of PPS, PEEK, PEKK, PEK, PE, PP are deemed suitable so as to achieve a desired melting temperature.

More preferably, use is made of a homopolymer or copolymer of polypropylene, and more particularly isotactic polypropylene that exhibits a large degree of crystallinity. Typical commercial isotactic polypropylenes are approximately 95% isotactic. Polypropylene has the advantage of having a methyl-side group, resulting in a helix-type chain structure. Therewith a good density is obtained such that the thermally bonded polymer has a good stability. Even though the textile material and polypropylene are structurally different materials, it is believed that under pressure, an interlayer of the two materials is formed. After cooling, the diffusion of the polymeric chains relatively to each other, which is merely possible by means of reputation, i.e. along the direction of the chain, is further hampered by the methyl-side groups of the propylene. An example of a suitable propylene homopolymer is for instance known from EP0400333A2. An example of a suitable propylene copolymer is for instance known from EP0472946. Blends may be used alternatively.

The textile material is suitably a textile based on a natural polymer, such as wool, cotton, linen, hemp, and derivatives thereof such as rayon. One most suitable type of rayon is viscose. The textile material may further be a mixture of a natural polymer and a synthetic polymer, such as polyester. Very good results have been obtained with viscose. Plates with such material demonstrated good flow behaviour and excellent water absorption when used with liquid desiccant. It is believed that rayon and particularly viscose is herein beneficial as its formation process comprises a treatment with a base, resulting in a salty material. More preferably, the content of rayon in the textile material is at least 50 wt %. The textile material may be used in a blend with a synthetic polymer material, for instance polyesters, such as PET, though polyamides (f.i. nylon), polyalcohols (PVA=polyvinylalcohol), polyacids (f.i. polystyrenesulphonic acid and polylactic acid) are not excluded. If used in a blend, it appears suitable that the amount of textile material is at least 50 wt %, more preferably at least 65 wt % or even at least 80 wt %. The higher content of textile material is beneficial so as to facilitate the thermoforming process. Furthermore, a higher content of textile material typically reduces swelling of the liquid desiccant, so that overall the amount of liquid desiccant material needed can be reduced. Less swelling moreover appears beneficial for lifetime of the laminate when used in an air-conditioner using such liquid desiccant. Suitably, the density of the layer of textile material is at most 90 g/m² (gsm), more preferably in the range of 30-80 gsm, for instance 40-70 gsm.

In a further implementation, the non-woven fibres are spunlaced fibres. Spunlacing is a process of entangling a web of loose fibres on a porous belt or moving perforated or patterned screen to form a sheet structure by subjecting the fibres to multiple rows of fine high-pressure jets of water, i.e. a form of hydro-entanglement. It appears that spunlacing brings increases water absorption.

It has been found in experiments with plates with a non-planar, corrugated surface used in an air-conditioner, with the flow of liquid desiccant in the second film and on its surface that good results were obtained with a pattern, wherein the ribbons had a height which was smaller than the distance between neighbouring ribbons (as measured from heart-to heart, i.e. periodic distance). More preferably the height was at most half of the periodic distance, and more preferably at most one third. Moreover, it is preferred that the height was preferably at most twice of the distance between adjacent plates. More preferably, the height is at most 50% higher than the distance between adjacent plates. Therewith, it is prevented that the width of an airflow channel significantly reduces near a rib (i.e. a peak). The periodic distance is for instance in the range of 1.0 to 5.0 cm. The distance between the plates is suitably at most 2.0 cm, preferably at most 1.0 cm.

The creation of the non-planar surface is more particularly embodied by means of thermoforming. This technique is well-known in the art. When carrying out thermal bonding and thermoforming, these processes may be done in two different steps or in a single step. Preferably, use is made of two separate steps, wherein the temperature of the thermoforming is sufficiently below the temperature of forming the laminate so as to prevent delamination. More preferably, the lamination step is carried out above the melting temperature, while the thermoforming step is carried out above the glass transition temperature, but below the melting temperature. The use of a cellulose derivative such as viscose, or cellulose acetate may be beneficial in the thermoforming process.

According to one implementation, the laminate may further be provided with channels designed for flow of a refrigerant. Such channels are suitably defined in an intermediate layer defined within the first film of the semi-crystalline polymer. Such intermediate layer may contain a material different from the semi-crystalline polymer. However, this is not deemed necessary. Articles with semi-crystalline polymer may be made for instance by means of moulding as known per se, or by laminating preformed sheets. Moreover, using more different materials than a minimum may complicate the process to create a non-planar surface in the thermally bonded laminate, and to reduce internal tensions in the thus re-shaped laminate.

The laminate is suitably used as a plate in an air-conditioner. Such an air-conditioner typically comprises a plurality of plates. Space between said plates is defined as air channels for air flow. Each such channel is thereto provided with an inlet and an outlet at opposed edges. The surface of the textile material is herein used for flow of liquid. The liquid may be pure water but also a salt solution. A liquid desiccant such as a salt solution of lithium chloride, calcium chloride, lithium bromide or other halide salt or potassium formate is suitable. Chlorate may further be suitable as an anion. Sodium, potassium, calcium and ammonium may be present as captions. Salt mixtures are not excluded. The salt solution is suitably a concentrated salt solution, such as a salt solution with a concentration just below its saturation level at an operation temperature. The air-conditioner is suitably operated at an operation temperature, or a range of operation temperatures above room temperature, for instance in the range of 40-80° C. The number of plates used in the air-conditioner is suitably more than 20, preferably more than 30 or even more than 50.

The air-conditioner module with said plates can be used as a drier. It could alternatively be used as part of a regenerator module. In such an embodiment, the use of liquid desiccant may be beneficial but does not appear necessary. Herein, it is deemed suitable that the module is further provided with channels defined within the first film of semi-crystalline polymer for a refrigerant. The module could be used, in again a different embodiment, as a cooler, wherein warm air is cooled by vaporization of humidity in the liquid desiccant.

It has been found in experiments with an air-conditioner module, that carry-over of liquid desiccant into the air flow may be substantially avoided. This is believed to result from the regular pattern of ribbons, and a minimum of protrusions. Suitably, a first and a second protrusion are provided adjacent to the edges of the plate, more particularly adjacent to the inlet and the outlet of the air. This pattern is particularly designed so that the module may be operated under conditions to give laminar air flow, at least substantially. Furthermore, the avoidance of carry-over is to be believed to be the result of the plates of the invention, and more particularly due to the use of the non-woven textile material, for instance comprising viscose.

In a very suitable embodiment of the invention, the module has a surface area of textile material of more than 200 m²/m³ module. The effective surface area may even be larger than 300 m²/m³ module. In a preliminary experiment, a surface area of over 400 m²/m³ was obtained Due to such a very high surface area an effective air-conditioner is obtained. The very high surface area is enabled in the use of a first film without hidden channels for refrigerant, i.e. without internal cooling. Furthermore, this is achieved by means of the plates which provide sufficient strength notwithstanding a small thickness per plate, and wherein the risk of carry-over is significantly reduced.

### BRIEF INTRODUCTION TO THE FIGURES

These and other aspects of the invention will be further elucidated with reference to the Figures and Examples. The Figures are not drawn to scale and are merely diagrammatical in nature. Equal reference numerals in different figures refer to identical or corresponding elements. Herein:

FIG. 1 shows a diagrammatical view of a first embodiment of the heat and mass exchange (HMX) module;

FIG. 2a-2d shows a schematical view of a sheet used in the HMX module and

FIGS. 3a, 3b and 4 show diagrammatical views of implementations of such a sheet.

### DETAILED DESCRIPTION OF ILLUSTRATED EMBODIMENTS

FIG. 1 shows in a diagrammatical view an HMX module 100 according to a first embodiment of the invention. The HMX module 100 comprises a plurality of sheets 10. The sheets are corrugated, as will be discussed with reference to following figures. Due to the corrugation and its orientation, the sheets that are inherently flexible are sufficiently stiffened so that they can be arranged at a relative short and uniform distance of each other without risking carry-over. Each of the sheets 10 is in the preferred implementation provided with layers of wicking material 11 of both the front and the rear side of the sheet. As shown in this FIG. 1, the layer of wicking material 11 may be subdivided into two lateral portions. However, this is not deemed particularly beneficial or preferred. The HMX module 100 is designed as a cross-flow module, such that the air and the liquid desiccant run in mutually perpendicular directions through the HMX module 100. It will be clear that an entirely perpendicular design is deemed advantageous and most straightforward for manufacturing, since the sheets can be of rectangular shape. However, this is not deemed necessary. Alternative shapes, such as that of a parallelogram, are however not excluded. Preferably, the module is configured such that the air channel extends laterally and that the liquid channel of the liquid desiccant extends vertically. In this manner, the liquid desiccant will flow within the HMX module 100 under the impact of gravity. The module as shown in FIG. 1 comprises tube connections 18, 19 for the provision and removal of liquid desiccant. Their location is not deemed critical. Though not shown explicitly, it is furthermore deemed beneficial that a reservoir of liquid desiccant is present so as to overlie the sheets 10 of the HMX module. The advantage thereof is that the liquid desiccant may be distributed into and onto the layers 11 of wicking material through apertures in a bottom of such reservoir, and typically spread over the entire surface thereof. Therewith, it is prevented that an initial flow of the liquid desiccant in a lateral direction needs to be converted into flow in a vertical direction.

The HMX module as shown in FIG. 1 may be used both as a dehumidifier and as a regenerator module, but also as any other module for use in an air-conditioning system, such as a cooling module. In a dehumidifier module—also referred to as a drier module—a stream of air is dried, and the liquid desiccant takes up humidity. In a regenerator module, a flow of liquid desiccant is dried and the air in the adjacent air channel is humidified. There is no need that exactly the same design of a module is used for the dehumidifier as for the regenerator module. By means of temperature control, the dehumidifier module may further be arranged to operate as a cooler. The shown module as shown in FIG. 1 comprises a plurality of sheets. The number of sheets can be chosen to desire in dependence of climate, air volume to be conditioned and space. As apparent from FIG. 1 the liquid channel is suitably longer than the air channel, particularly in a drier module. With a well regenerated liquid desiccant, for instance an aqueous LiCl solution of sufficient concentration (i.e. typically close to the maximum loading concentration), drying turns out more effective in the first portion of the air channel. However, the liquid desiccant material does not need to be an aqueous LiCl solution, but could alternatively be a salt solution comprising various soluble salts.

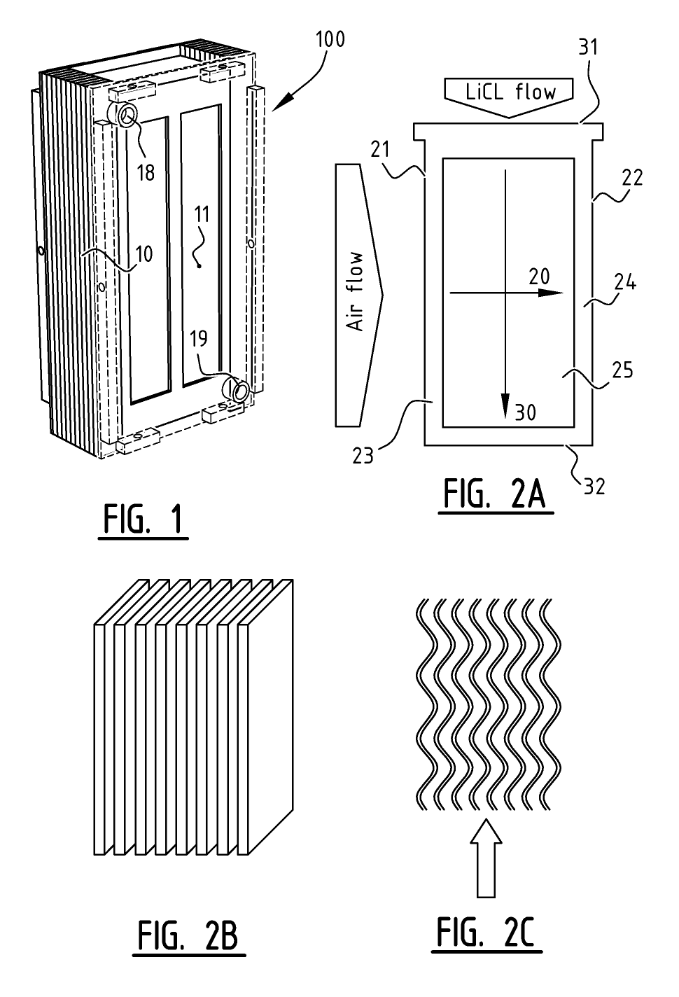

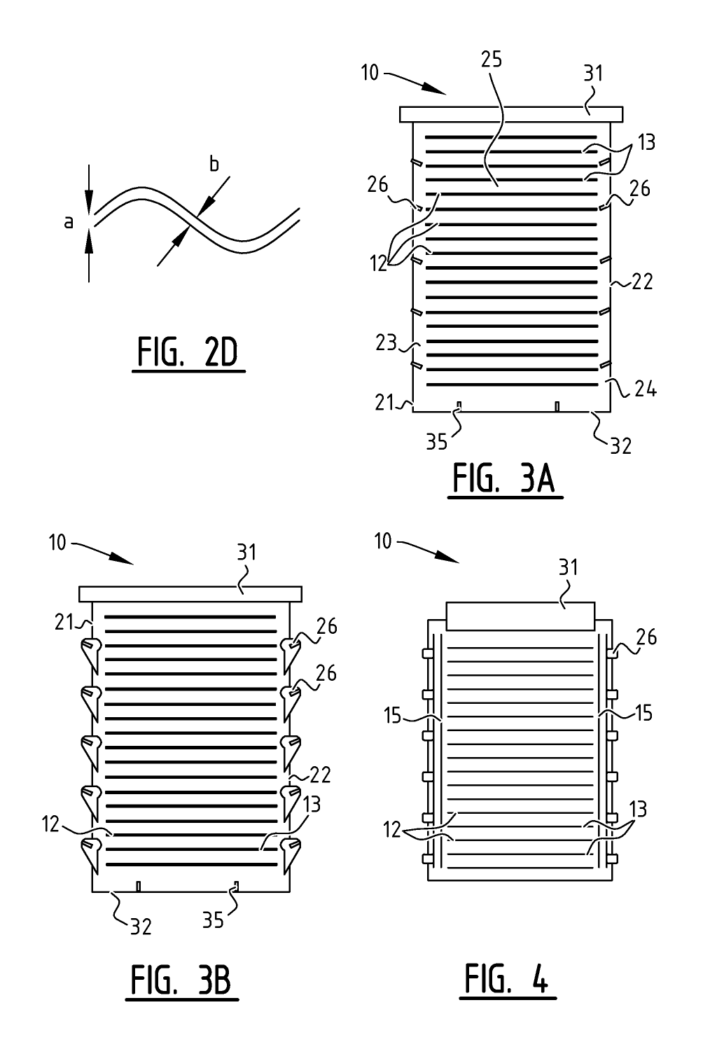

FIG. 2a shows in a schematical view a sheet 10 for use in the module of the invention. An air channel 20 is defined between two sheets 10 and is indicated for sake of reference. It is configured in a lateral direction. The air channel 20 is provided with an inlet 21 and an outlet 22. Air in the air channel 20 will first pass an accommodation area 23 then an active area 25 and finally an outlet area 24. The active area 25 is configured to enable exchange with the liquid channel 30 that is defined at the surface of the layer of wicking material (on the sheet 10). It is observed for clarity that the layer of wicking material may extend beyond the active area 25. However, the active area 25 is further defined by means of the entry regions of the liquid desiccant, which are defined at the inlet 31 of the liquid channel 30. These entry regions are typically defined by means of a manifold. The liquid channel 30 is ended at the outlet 32. This outlet 32 is suitably embodied as a container for the liquid of several parallel liquid channels 30. It can be seen that the liquid channel 30 thus has a smaller width (i.e. substantially as defined by the active area 25) which is smaller than the length of the air channel 20 (i.e. the distance between the inlet 21 and the outlet 22 thereof).

FIG. 2b schematically shows the generation of a module from a plurality of sheets 10 and the air channels 20 in between of the sheets 10. FIG. 2c shows a representative corrugation when seen from the entry of the air channel 20. The arrow indicates the extension of the liquid channel 30. The view of FIG. 2c is in fact a cross-sectional view of the air channel. FIG. 2d shows a detail from FIG. 2c. It is apparent from this FIG. 2c that in order to prevent carry-over, the liquid desiccant needs to have sufficient adhesion to the underlying surface. It preferably flows in a steady state. Most suitably, the film onto the surface of the layer 11 of wicking material (not shown in this FIG. 2c) is sufficiently thin. The film thickness is thinned, in one preferred embodiment in accordance with the invention, by using a specific manifold, wherein the liquid desiccant first flows through a series of slots and is thereafter laterally distributed to cover the area of the liquid channel between the slots.

As shown in FIG. 2d, the distance between the sheets 10 varies somewhat due to the wave-shaped pattern of the sheets 10. In fact, the distance a is larger than distance b. This variation in the distance is an important reason for arranging the wave along the length of the liquid channel rather than along the length of the air channel. If arranged along the length of the air channel, the variation in distance would result in a temporary narrowing of the air channel, resulting in an increase in flow rate (followed by a reduction in flow rate). Such variations in air flow rate would increase the risk of carry-over. By arranging the waves along the length of the liquid channel, the air flows substantially parallel to the waves. This turns out beneficial. In fact, one may consider an air channel to be divided in a large number of parallel portions, extending laterally and each having the same length. The lateral portions will have slightly varying height (i.e. distance between the sheet). However, the height of a single lateral portion is substantially constant along its length, at least within the active area, where exchange with the liquid channel occurs. As a result, a single air drop travelling in a single lateral portion will not experience any changes in height within the active area. This therefore reduces a chance that the air drop starts to move in a turbulent manner, and therewith may interfere with the liquid channel to result in droplet formation of liquid desiccant, i.e. carry over. Additionally, it was found that this configuration has a lower pressure drop, as compared to an alternative configuration.

In one implementation according to the invention—not shown—the height of a ridge and a valley is higher in the middle part of the air channel than close to the outlet area 24. Herewith, it may be prevented that carry-over occurs at the end of the air channel due to a sudden change in direction of the air channel. In one further or additional implementation according to the invention, the ridges and valleys extend from the active area 25 into the outlet area 24. Therewith, it is achieved that the end of said ridges and valleys, corresponding to a change in orientation of the air channel is at least substantially outside the exchange surface between air and liquid desiccant material.

In again one further implementation, the height of ridges and valleys may be lower in a bottom part of the air channel than in a top part. The liquid desiccant may gain velocity in the course of flowing downwards. In a dehumidifier module, it additionally may warm up. Therefore, the lower part is more sensitive to carry over. This may be compensated by less steep ridges and valleys, to prevent any ejection of single droplets of liquid desiccant.

FIG. 3a shows in a diagrammatical view the sheet 10 more specifically. Herein, it is indicated that the sheet 10 is provided with ridges 12 and valleys 13, in alternating arrangement. The sheet 10 suitably has a shape of a wave, wherein the ridges 12 extend into a first direction and the valleys 13 extend into the opposite direction. With these ridges 12 and valleys 13 a corrugated surface is created that is deemed positive for the necessary strength of the sheet 10, without increasing risk for carry-over. More particularly, the wave may be a sine wave. Its amplitude relative to the length of a period may be optimized, so as to prevent significant acceleration of droplets with the liquid desiccant that could spring away from the surface into the air. Moreover, the edges of the sheet 10 are at least substantially planar. This facilitates assembly of the sheet 10 into the module, particularly by means of a distance holder as will be explained with reference to further figures.

In the shown embodiment, the ridges 12 and valleys 13 extend parallel to the width of the liquid channel 30, such that the liquid channel 30 in fact includes a curved trajectory. However, the air channel 20 is substantially planar over the width of the liquid channel, i.e. in the area where the liquid channel and the air channel have an interface. This has the advantage of minimum disturbance of air flow. As a consequence, carry over can be prevented, at least substantially, while the sheets are very thin. In this manner, a large packing density of sheets per unit volume is achieved, resulting in a large exchange area between the air channels and the liquid channels. In tests with a preliminary version of the heat and mass exchange module according to the invention, wherein the air flow was laminar and a liquid channel wave-shaped, no carry-over was found to occur. The sheet 10 is suitably created in a multistep process. In a first process, layers of wicking material are added to a carrier. The carrier is suitably an engineering plastic, such as PET, polycarbonate, high-density polyethylene, polypropylene. Good results have been achieved with polypropylene. The wicking material typically comprises a fibrous material, such as a textile material, for instance cotton, linen, viscose or nylon fibres. Alternative hydrophilic, fibrous materials, such as starch and particularly treated starches, are not excluded. Natural rather than synthetic fibres are deemed preferred as a basis for the wicking material, since they are chemically inert and stable to LiCl and other saline desiccants. Viscose is deemed a particularly preferred choice. Rather than a single material, a blend of materials may be applied, for instance a blend of a viscose with a carrier material, for instance an engineering plastic, such as polyethylene terephthalate, polyethylene, polypropylene, polyvinylchloride, polyester. A blend with up to 50 wt % carrier material, for instance 25-40 wt % carrier material is deemed very suitable. Preferably, use is made of a non-woven material that appears to be beneficial for the further step of the process.

The addition process may be achieved either by dipping (passing of a bath), coating, or laminating. The laminating process is preferred. The carrier may have been pre-treated to improve adhesion, for instance by means of a surface treatment (such as a plasma treatment), or in the provision of an adhesion promoter or even a glue layer. In one advantageous embodiment, use is made of lamination under pressure, wherein an interlayer is formed between the carrier and the layer of wicking material. Good results have been obtained therewith. An advantage of this joining technique is that there is no glue needed, which could be sensitive to dissolution under the impact of the liquid desiccant that is typically very salty and corrosive. The glue may further have an impact on the porosity of the wicking material, and therewith on its wicking properties. In a further process step, the combined material is then thermoformed so as to create the corrugation of the surface, more particularly the ribbons, valleys and any protrusions. Herein, the use of non-woven material is deemed beneficial, as it provides less resistance against the concomitant extension than any woven material. The thermoforming step was carried out in a manner so as to obtain an increase in surface area (‘stretch’) of 10-25%. It was found that this stretch could be made without any delamination to occur between the carrier and the layer of wicking material. The thermoformed sheet moreover turned out stable up to at least 100° C., or even up to 120° C.

FIG. 3a furthermore shows the presence of spacers 26 and 35 located sidewise and at the bottom of the sheet 10, which preferably have a strip-wise extension and are assembled to a plurality of sheets 10. The spacers 26 are arranged within the accommodation area 23 and the outlet area 24, which are most preferably substantially or completely planar. Whereas FIG. 3a shows 5 distance holders 26 in said areas 23, 24, the actual number may vary. In the present configuration, a larger number of spacers 26, for instance 12-25 per meter per area 23, 24, seems useful, so as to act as a stiffener. The spacers 26 in the accommodation area 23 are oriented downwards in the configuration shown in FIG. 3a. The spacers 26 in the outlet area 24 are oriented upwards in the configuration shown in FIG. 3a. In a rare occasion that any desiccant material may get in contact with a spacer 26 arranged outside the liquid channel, an oblique orientation is deemed beneficial to prevent any accumulation of liquid desiccant material. The oblique orientation makes that the liquid desiccant will flow downwards back onto one of the sheets 10. In order to prevent droplet formation, the spacer preferably is provided with a concave shape in the area between adjacent sheets, such as an inversed V-shape.

One further advantage of the design shown in FIG. 3a—as opposed to a design wherein the ridges 12 and valleys 13 are oriented along the width of the air channel 20, is that the bottom side of the sheet does not need to be fixed within a rigid holder, so as to provide sufficient stiffness. The absence of such a rigid holder allows the sheets to hang down, for instance in a bath of liquid desiccant, or in a sponge. The sheet may then expand and contract freely during temperature variations, i.e. between use and non-use, or between operating at different temperatures. As is well known, polymers have a large coefficient of thermal expansion (CTE). The expansion and contraction upon temperature variations may lead to warpage and other artefacts, particularly if a sheet with a large CTE is fixed to a sheet or component with a smaller CTE. Due to the free edge, the expansion, particularly in the vertical direction, will not cause problems. It is observed for clarity, that a free edge is not the only solution to the problem of differential thermal expansion. However, not all of these known solutions, such as the use of an elastomer interlayer with a very large CTE, is feasible in the context of air-conditioner modules with liquid desiccant. The liquid desiccant is known to be corrosive, but the lifetime of the air-conditioner module is still required to be high.

The configuration of FIG. 3b differs from that in FIG. 3a in the shape of the spacers 26. Herein, the distance holders are arranged in extending parts 27, which extend outside the sheet 10. The advantage hereof is that such an arrangement further reduces the risk that a spacer 26 will be covered with liquid desiccant. It is understood that the liquid desiccant, when it would flow outside the intended area of the liquid channel 30, would follow the edge of the sheet 10. Because the spacer 26 is present in extending part 27, it will remain dry. It is observed for clarity that extending parts 27 could be applied only in limited regions, wherein liquid flow can be expected.

FIG. 4 shows a further configuration of the sheet 10 comprising a pattern of ridges 12 and valleys 13 as well as stiffening protrusions 15. In this preferred configuration, the pattern of ridges 12 and valleys 13 is repetitive, and is arranged so that the trajectory of the air in the air channel is straight, while the liquid channel is curved along its length. In addition, the sheet 10 comprises stiffening protrusions. These are arranged outside the active area 25, in which the pattern of ribbons 12 and valleys 13 is arranged, and effectively within the accommodation area 23 and the outlet area 24. In the present configuration, a first and a second stiffening protrusion 15 are defined, both extending in this configuration along the width of the air channel (i.e. along the width of the active area 25 as shown in FIG. 2). While a longer stiffening protrusion is deemed beneficial, it is not excluded that this long protrusion is subdivided into two or more shorter protrusions. Moreover, more protrusions could be present, particularly in the accommodation area and in the outlet area. This is however neither deemed necessary nor deemed advantageous. Both protrusions 15 have the same dimensions in this configuration. Again, this may be useful, so as to obtain a design that is most symmetrical, but it does not appear necessary.

### Example 1

Tests were made to identify sheets and/or laminates that were sufficiently wetted when a LiCl solution was poured onto the material. Use was made of a test set up, wherein a sheet was hung in a frame and was clamped on its top side and its bottom side. On the side edge, it was connected to a frame at regular distances. The sheet has a length of 600 mm and a width of 400 mm. The LiCl was sprayed onto the surface of the laminate by means of nozzles arranged at the top side of the sheet in the test set up. The sheets were flat, i.e. no corrugations were present. The results are summarized in Table 1.

| | | Textile | | |
|---|---|---|---|---|
| | Sheet | material | | Flow |
| Nr | material | (^{x}) | result | rate |
| COMP | Anodized | — | No wetting | |
| 1 | sandblasted | | | |
| | aluminium (Al) | | | |
| COMP | Sandblasted | — | No direct wetting, | |
| 2 | polycarbonate | | and not sufficient | |
| | (PC) | | with roller | |
| COMP | Sandblasted | — | No direct wetting. | |
| 3 | polypropylene | | No good wetting | |
| | (PP) | | when distributed | |
| | | | with roller | |
| COMP | Sandblasted | Hydrophilic | Good with water, | |
| 4 | (PP, PC, Al) | coating | bad with LiCl | |
| COMP | Sandblasted | Woven | No good wetting, | |
| 5 | | glassfiber cloth | too hydrophobic | |
| 1 | PET | Viscose 100% | Good | 130 |
| | | (⁺) | | ml/min |
| 2 | PET | 65% viscose, | Good | Up to 150 |
| | | 35% PET (*) | | ml/min |
| 3 | PP | 60% viscose, | Good | |
| | | 40% PP | | |
| 4 | PP | Cotton | Good | |
| | | spunlaced | | |
| | | (nonwoven), 30 | | |
| | | g/m² | | |

(^{x}) textile laminated with glue to the sheet material, e.g. ethylene vinyl acetate (EVA) copolymer
(⁺) viscose supplied as Lidro ™ as 100% viscose PEFC, 57 g/m², spunlace material
(*) mixture supplied as Lidro ™ , 100 g/m², spunlace material

### Example 2

Individual sheets were thermoformed using a single sheet vacuum thermoformer tool. The tool was set up to define a wave shaped pattern into a sheet. The wave-shaped pattern was chosen to arrive at an expansion of the surface area of 20%. The edges of the sheet were kept planar. The tool included a first and a second mould with the said pattern and the heating means to apply a temperature to the moulds. A polypropylene sheet of 0.5 mm thickness and size of 400×600 mm that had been given a corona treatment was combined with a layer of viscose as used before. The two layers were laminated in the mould and heated for 1 minute to 180° C. A single laminate was obtained, that could be released immediately, but also be gradually cooled down. The thermoformed sheet had a good stability. Flow properties of LiCl solution were tested and turned out good.

1. A laminated sheet comprising a first film of a polymer, a second film of a non-woven textile material, and a third film of a non-woven textile material, which textile material comprises a natural polymer or a derivative thereof, wherein the first film is arranged between the second and the third film, and wherein the second film and the third film of the laminated sheet are provided with a corrugated surface, and wherein the sheet is a corrugated sheet that comprises a plurality of ridges and valleys in a first direction, and one stiffening protrusion or a couple of stiffening protrusions arranged in a direction at least substantially perpendicular to the ridges and valleys.

2. The laminated sheet as claimed in claim 1, wherein the natural polymer is chosen from cotton and rayon.

3. The laminated sheet as claimed in claim 2, wherein the natural polymer is viscose rayon.

4. The laminated sheet as claimed in claim 1, wherein the second and the third film comprise a blend of the non-woven textile material and a synthetic polymer material.

5. The laminated sheet as claimed in claim 4, wherein the textile material is at least 50 wt % of the laminated sheet.

6. The laminated sheet as claimed in claim 1, wherein the non-woven material is spunlaced.

7. The laminated sheet as claimed in claim 1, wherein the film of non-woven textile material has a density of at most 90 g/m².

8. The laminated sheet as claimed in claim 1, wherein the first film comprises polymer that is semi-crystalline or in a glassy state at room temperature, and optionally at an operating temperature up to 40° C., and wherein the semicrystalline polymer optionally has a melting temperature in the range of 100-240° C. or in the range of 140-200° C.

9. The laminated sheet as claimed in claim 8, wherein the semi-crystalline polymer is a polypropylene homopolymer or copolymer.

10. The laminated sheet as claimed in claim 1, wherein the first film and the second film contain an interlayer wherein the polymer and the textile material are entangled.

11. The laminated sheet as claimed in claim 1, wherein an adhesive layer is present, optionally as a layer of a vinylic copolymer of an olefin and a vinyl ester.

12. The laminated sheet as claimed in claim 1, wherein the plurality of ridges and valleys is present in an active area of the laminated sheet and a first and a second stiffening protrusion are present outside the active area.

13. The laminated sheet as claimed in claim 1, wherein a first and a second stiffening protrusion are provided adjacent to opposed edges of the laminate sheet.

14. The laminated sheet as claimed in claim 1, further comprising a planar surface portion in the form of an annular ring at an edge of the laminated sheet.

15. The laminated sheet as claimed in claim 1, wherein the laminate is a thermoformed sheet, wherein the ridges, valleys and protrusion or the couple of stiffening protrusions in the surface are defined by thermoforming.

16. The laminated sheet as claimed in claim 1, wherein the corrugated surface has a surface area after thermoforming that is 10-25% higher than a surface area prior to thermoforming.

17. An air-conditioner comprising a module with a plurality of plates, each having at least one surface designed for liquid flow adjacent to a channel for air flow, such that in use liquid may evaporate and be transferred into the air flow or humidity in air may condensate at said surface with liquid flow, wherein the laminated sheet as claimed in claim 1 is used as a plate.

18. The air-conditioner as claimed in claim 17, wherein the textile layer of the laminated sheet is part of a liquid desiccant channel of the air-conditioner, said liquid desiccant channel further having an entry and an exit at opposed edges of the plate.

19. The air-conditioner as claimed in claim 18, wherein the channel for air flow has an inlet and an outlet at opposed edges of the plate arranged sidewise to the edges at which the entry and the exit of the liquid desiccant channel are arranged, thus providing a crossflow module.

20. The air-conditioner as claimed in claim 17, wherein the number of plates is at least 20.

21. The air-conditioner as claimed in claim 17, further comprising a distance holder for setting a uniform distance between the individual plates.

22. Use of the air-conditioner as claimed in claim 17 for drying of air and/or for cooling of air.

23. A method of manufacturing a laminated sheet as claimed in claim 1, wherein a first film of a polymer optionally comprising a semi-crystalline polymer and a second and a third film of a non-woven textile material comprising a natural polymer are thermally bonded and thereafter thermoformed to provide a corrugated sheet having corrugated surfaces and provided with a plurality of ridges and valleys in a first direction, and a stiffening protrusion or a couple of stiffening protrusions arranged in a direction at least substantially perpendicular to the said ridges and valleys.

24. The method as claimed in claim 23, wherein the thermal bonding occurs at a temperature above the melting temperature of the semi-crystalline polymer.
